(19) United States
(12) Patent Application Publication
(10) Pub. No.: US 2002/0087988 A1
(43) Pub. Date: Jul. 4, 2002

(54) Interactive TV contextual content surfing using inter-channel hyperlinking: systems, methods & program products

(75) Inventors: James S. Lipscomb, Yorktown Heights, NY (US); Lurng-Kuo Liu, White Plains, NY (US); Liang-Jie Zhang, White Plains, NY (US)

Correspondence Address: Joseph C. Redmond, Jr., Morgan & Finnegan, L.L.P., 345 Park Avenue, New York, NY, 10154-0053, US

(73) Assignee: International Business Machines Corporation, Armonk, NY (US)

(21) Appl. No.: 09/749,407

(22) Filed: Dec. 28, 2000

(51) Int. Cl. G06F 3/00; H04N 5/445; G06F 13/00; H04N 7/173

(52) U.S. Cl. 725/51; 725/46; 725/109

(57) ABSTRACT

An interactive TV contextual content surfing method, system and program product enables viewers to surf from one related program to another through hyperlinking. A TV broadcast station receives interactive TV program content generated by creators. The content is categorized by the creator and provided to the broadcast station in the MPEG or web-streaming video/audio formats. A broadcast server stores a dynamic table of correspondence between TV program categories and TV channel numbers. The hyperlinking information contains a list of channels that broadcast the same nature of programs by referencing the correspondence table. The server broadcasts the hyperlinking information to the list of channels. The broadcast network carries the TV programs and associated classification information in separate channels to the local TV station for retransmission to TV devices including set-top boxes. The set-top box stores program information by categories in classification tables; contents of a TV program guide section; and recorded programs.

### RELATED APPLICATION

Co-pending application entitled “Interactive TV Audience Estimation and Program Rating for Real-Time Using Multi Level Tracking Methods, Systems and Program Products” (SOM9-2000-0013) by James S. Lipscomb, Lurng-Kuo Liu and Liang-Jie Zhang, Ser. No. ______, filed Dec. 28, 2000, assigned to the same assignee as that of the present invention and fully incorporated herein by reference.

### BACKGROUND OF INVENTION

1. Field of Invention

This invention relates to Interactive Television systems, methods and program products. More particularly the invention relates to Interactive TV contextual content surfing using inter-channel hyperlinking systems, methods & program products.

2. Description of Prior Art

As a result of the steady progress in digital transmission and compression technology, the combination of these two technologies exhibit a powerful synergy in providing new communication paradigms for TV. Digital transmission is extensively used as an information transmission means and more and more TV channels can be fitted into a broadcast pipe for broadcasting. Therefore, it becomes desirable to provide a mechanism to TV viewers for simplifying TV-channel surfing based on the TV viewers' interest. What is needed in the art is a generalized framework for delivering content-sensitive hyperlinking information to TV viewers.

Prior art related to interactive television includes:

U.S. Pat. No. 5,617,565 issued Apr. 1, 1997 discloses a procedure for selecting and storing data elements communicated from a common database to viewers of the database utilizing a communication link between each transmitter and a concomitant receiver accessible by the viewer. The transmitted information is augmented with attributes, which are used at the receiver to select and then store locally only that information of interest to each receiver's viewer, wherein the attributes and the viewer selection pattern determine the criteria for storing information locally. Attributes include: utility of each data element in time; interest categories and level of interest for each of the categories determined for the collective viewers; repeat time to the data element; and a hyperlink to associated data elements.

U.S. Pat. No. 5,982,445 discloses textual and graphical displays provided on a television screen using a hypertext markup language (HTML). On-screen display devices allow a viewer to invoke hyperlinks to different pages of HTML-coded data in addition to function calls for controlling television and non-television appliance functions. A method provides HTML-coded display data, which is processed to provide a signal suitable for reproduction on a television. The display data may provide information on a featured movie or other presentation of an associated video programming service signal such as a network television broadcast. Function calls allow the control of various television functions and programming options, such as the purchase of pay-per-view programming, or television display options such as aspect ratio, channel, brightness, picture-in-picture, or split-screen. Non-television appliances, which may be controlled with function calls, include audio equipment which is associated with the programming service (e.g., surround sound, filtering) in addition to, for instance, a home heating and air conditioning system or other household appliances. The invention allows a designer to adapt the vast HTML resources of the Internet for use in the television environment for entertainment, educational or informational purposes.

U.S. Pat. No. 6,025,837 disclose an interactive entertainment system including a program provider, which distributes video content programs to multiple subscribers over a distribution network. Each subscriber has a viewer interface unit, which receives the digital video program and converts it for display on a television, monitor, or other display unit. The viewer interface unit has a processor and memory. An electronic programming guide (EPG) resides in the memory and is executable on the processor to organize programming information that is descriptive of the programs supplied over the interactive entertainment system. The EPG supports a viewer interface (UI), which visually correlates programs titles to scheduled viewing times. A hyperlink browser also resides in memory and is executable on the processor. One or more hyperlinks, which reference target resources containing interactive content related to the video programs, are integrated as part of the EPG UI. The hyperlinks can be placed in the program tiles, channel tiles, or description area, and can be situated alone or embedded within other text. When a viewer activates a hyperlink within the EPG, the viewer interface unit launches the browser to activate the target resource specified by the hyperlink. The data retrieved from the target resource is then displayed on the display unit. The viewer can also drag a particular program or channel label from its location within the EPG UI and drop the label at another location on the display unit. This drag-and-drop operation associates an instruction with the label that will execute in response to activation of the label. The instruction might cause the visual display unit to tune to the program or channel represented by the particular label, or to initiate procedures to record the program when it begins playing, or to jump to a related target resource, such as a Web site.

Other prior art includes web sites, as follows:

Obvious Technologies at world wide web site Obvious.Com, which plays web video in a web browser.

Veon at world wide site Veon.Com, which has menus and floating links to web information. Videotechnologies at world wide web site Videotechnologies. Corn.

None of the prior art discloses or suggests an interactive TV contextual content surfing using hyperlinking, which allows viewers to have the option to surf only TV channels related to their current interest, and where hyperlinks are developed from the general, overall classification of the entire video.

### SUMMARY OF THE INVENTION

An object of the invention is interactive TV contextual content surfing methods, systems and program products using inter-channel hyperlinking.

Another object is interactive TV contextual content surfing methods, systems and program products providing alternative embodiments of inter channel hyperlinking.

Another object is a content creation station generating and transmitting interactive TV programs including program classification information for interactive TV contextual surfing.

Another object is a broadcast station for broadcasting interactive program information and classification information in a streaming data format for interactive TV contextual surfing.

Another object is a broadcast server for processing program classifications in related categories for interactive TV contextual surfing.

Another object is a broadcast server for hyperlinking program information in related categories for interactive TV contextual surfing.

Another object is broadcasting program information and classification information in separate channels to receivers for interactive TV contextual surfing.

Another object is a receiver for receiving and storing TV broadcasts in classification categories for interactive TV contextual surfing.

These and other objects, features and advantages are achieved in a TV broadcast station, which receives interactive TV Program Content generated by Creators. The Content is categorized by the Creator including title, producer, director, type of program (e.g., sports), subtype of program (e.g., football), director/producer, players/actors, etc. The Content is provided to the broadcast station in the MPEG or web-streaming video/audio formats. Program classification categories are delivered to the broadcast station via an Internet connection. A broadcast server equipped with a correspondence table stores a dynamic table of correspondence between TV program categories and TV channel numbers. Hyperlinking information is created by the broadcast server. The hyperlinking information contains a list of channels that broadcast the same nature of programs by referencing the correspondence table. The server broadcasts the hyperlinking information to that list of channels. The broadcast network carries the TV programs and associated classification information in separate channels to the local TV station for retransmission to TV devices including settop boxes. The Internet may serve as one of the channels for providing the program classification information and receiving viewer input. Alternatively, the broadcast network may send the program information and associated classification information directly to the TV set top box. The set-top box processes the broadcast hyperlinking information and displays it on the TV screen. The set-top box stores program information by categories in classification tables, contents of a TV program guide section, and recorded programs. A viewer interacts with the set-top box to select a category of programs from the Classification tables. From time-to-time the viewer may select a new program to watch or may ask to hyperlink to a new program related to the one being watched. In the event of a hyperlink from one program to another, the system may choose either to go directly to the new program or it may let the viewer choose among the various ways the program was classified, provided that one or more programs is available. Otherwise, the offer to hyperlink is not sensitive to selection. Once the classification is chosen, there will be at least one program to go to. If there are several programs to choose from, the system may select one or the viewer may be allowed to select one. The viewer may then accept the program as chosen, which need involve no explicit viewer interaction.

### DESCRIPTION OF THE DRAWING

The invention will be further understood from the following detailed description of a preferred embodiment taken in conjunction with an appended drawing, in which:

FIG. 1 is a system diagram of an interactive TV contextual content surfing system using inter-channel hyperlinking and incorporating the principles of the present invention.

FIG. 2 is an overall flow of data for direct channel hyperlinking in the system of FIG. 1.

FIG. 3 is one embodiment of data layout for direct channel hyperlinking in the system of FIG. 1.

FIG. 4 is a flow diagram for direct channel hyperlinking in the system of FIG. 1.

FIGS. 5 and 5A are flow diagrams describing alternative embodiments for the hyperlinking shown in FIG. 4.

### DESCRIPTION OF PREFERRED EMBODIMENT

Briefly, before describing the preferred embodiment, an overview of the system is presented to aid in a better understanding of the invention. An interactive TV contextual content surfing system allows TV viewers to have the option to surf directly to TV channels that are related to their current interest without necessarily a separate step to access the program guide. Of course, the system will not prevent TV viewers from selecting other categories of program if they choose to do so. The interactive TV contextual content surfing system is composed of a plurality of TV devices connected through a broadcast network, and a broadcast server through which TV programs and additional data are delivered to TV devices. The TV device is equipped with viewer interfaces capable of taking a viewer's input and responding to it, and a means to recognize and process the additional data that it receives from the broadcast network. To achieve the above object, the interactive TV contextual content surfing system is characterized in that: the broadcast server is equipped with a correspondence table storing means for storing a dynamic table of correspondence between TV program category and TV channels number. The broadcast server creates hyperlinking information, which contains a list of channels that are broadcasting the same nature of program by referencing the correspondence table, and broadcasts the hyperlinking information to that list of channels. The TV device, upon successfully processing the broadcast hyperlinking information displays it on the TV screen, takes the viewers' input and surfs among the channels specified in the hyperlinking information.

In one embodiment a generalized framework is provided for delivering content-sensitive hyperlinking information to TV viewers. TV programs are categorized at network operators' headend based on the program's nature and show time. For each category at a given time, hyperlinking information, which contains a list of channels that are broadcast in the same category of program is created and broadcast as supplemental data in that channel.

In another embodiment, information about program categories is broadcast to the settop box on an auxiliary channel not being displayed. Besides grouping programs in categories at the headend, the settop box itself may group programs based on information directly from the TV viewer or by deduction based on TV view habits as with other vendors products. These groupings may also be displayed on the channel being viewed.

In another embodiment, when a recorded program has stored with it the information that classifies it the viewer can after selecting the program or while watching it surf to other related programs broadcast at that time, stored, or scheduled (in which case the viewer goes to a play/record dialog for the future program).

In still another embodiment while looking over scheduled programs in a program guide the viewer may surf to other related programs playing at the time, recorded, or scheduled (in which case the viewer goes to a play/record dialog for the future program).

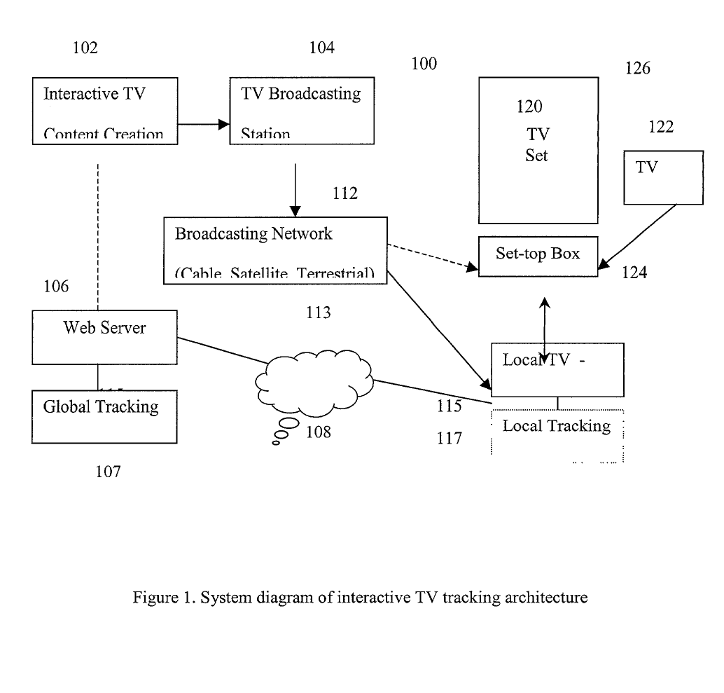

Turning to FIG. 1, an interactive TV contextual content surfing system 100 includes an Interactive TV content creation station 102 linked to a TV broadcasting station 104 by cable or like and to a Web server 106 and global tracking server 107 by a network 108. The content creator install “hot spots” in the content for hyperlinking to other content. The process of installing “hot spots” and hyperlinking is well known in the art and is described for example in U.S. Pat. No. 5,841,978 entitled “Networking Using Steganographically Embedded Data Objects” issued Nov. 24, 1998 and U.S. Pat. No. 5,918,012 entitled “Hyper Linking Time Based Data” issued Jan. 29, 1999. The broadcasting station 104 is further linked to a broadcast network 112, serving a plurality of local TV stations 115 including a local tracking server 117 linked to the networks 112 and 108, respectively implementing an Interactive TV Tracking architecture of the present invention. The station 115 serves a plurality of local receivers, each including a TV set 120 having a TV screen 122, a set-top box 124, a remote control device 126 and communications circuitry (not shown). The TV screen is coupled to the set-top box. The set-top box is capable of processing broadcast hyperlinking information and transmitting to the TV screen for display. The communications circuitry is capable of coupling the set-top box to the remote broadcast server via the broadcast network. The system incorporates the following features:

1. A viewer can hyperlink from a program being viewed to a related program.

2. A viewer can hyperlink from a scheduled or recorded program to a related program.

3. Where a related program may be in progress, previously recorded, or scheduled or broadcast in the future, the viewer can hyperlink to a recording dialog.

4. Hyperlinking information is downloaded as supplemental data in an active channel showing or on an auxiliary channel not being displayed.

5. A settop box itself may group programs by deduction based on viewer TV habits or based on information directly from the TV viewer.

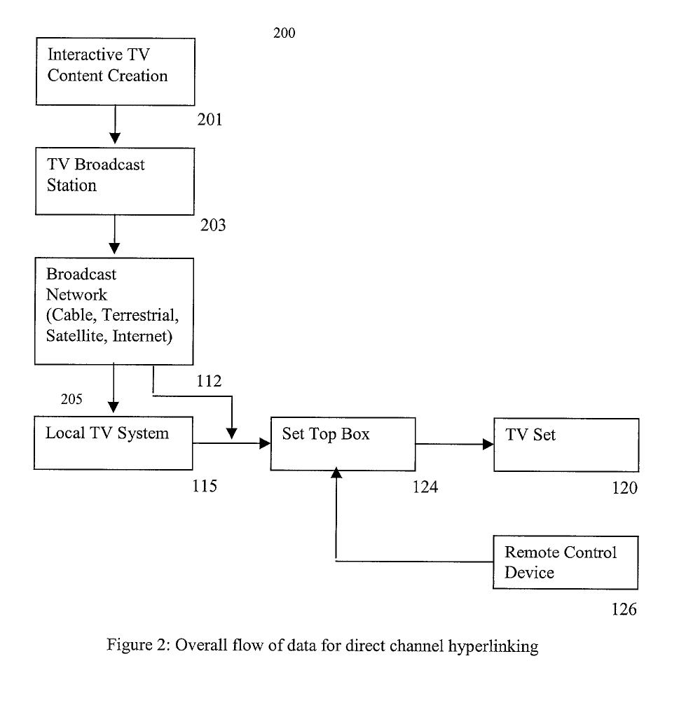

FIG. 2 taken in conjunction with FIG. 1 shows an overall interactive TV data flow process 200. In step 201, interactive TV program content is created in station 102 by a creator. The program content is in the MPEG or web-streaming video and audio format. The programs are classified by categories, including title, producer, director, type of program (e.g. sports), subtype of program (e.g. football), director, producer, players, actors, etc. The classifications associated with each program are delivered as data embedded in an MPEG-2 stream, on a separate channel 103 over an IP Internet connection, etc. Program classification categories are delivered to the broadcast station via an Internet connection 108. A broadcast server in the station is equipped with a correspondence table stores a dynamic table of correspondence between TV program categories and TV channel numbers. Hyperlinking information is created by the broadcast server. The hyperlinking information contains a list of channels that broadcast the same nature of programs by referencing the correspondence table. The server broadcasts the hyperlinking information to that list of channels. The broadcast network carries the TV programs and associated classification information in separate channels to the local TV station for retransmission to TV devices including settop boxes. The Internet may serve as one of the channel for providing the program classification information and receiving viewer input. Alternatively, the broadcast network may send the program information and associated classification information directly to the TV set top box. In step 203, the TV Broadcast Station 104 provides both the audio/video content and the program classifications again, either together or over separate channels to the Broadcast Network 112. In step 205, the Broadcast network provides this and other programs and classifications to the Local TV System 115 for redistribution to the viewer's Set Top Box 124, or the broadcast network sends the information directly to the viewer's Set Top Box. The information and programs are processed, as will be described hereinafter, and then are displayed on the viewer's TV Set 120, which the viewer sees and interacts with through the set top box 114 and/or remote control 126.

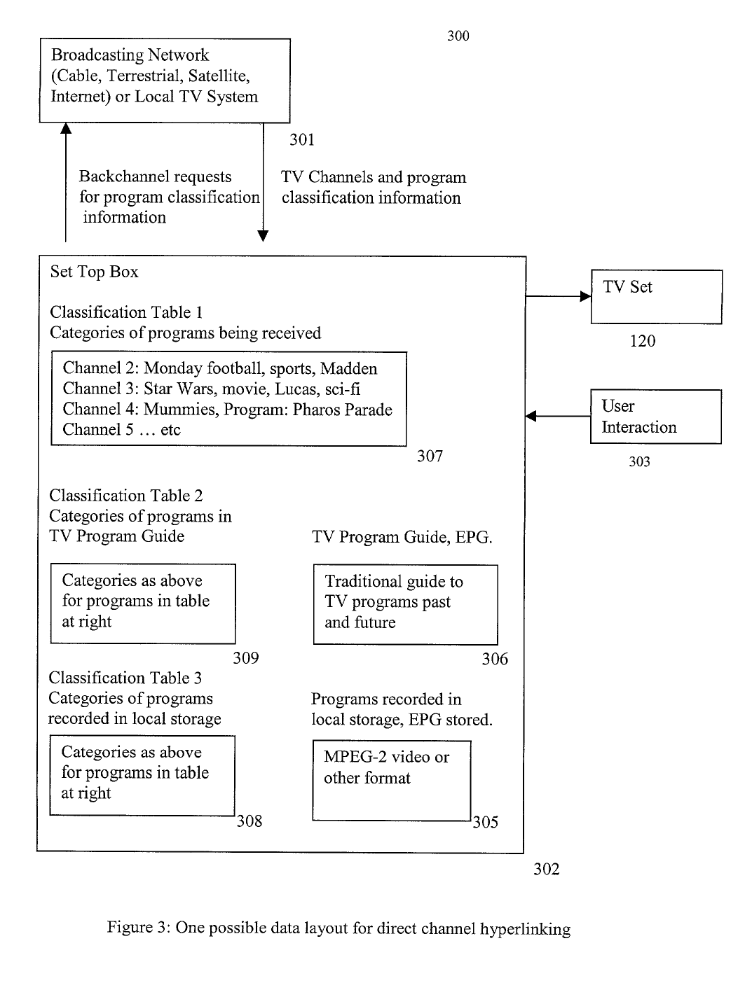

FIG. 3 in conjunction with FIG. 1 shows one embodiment of a data layout 300 for direct channel hyperlinking. The Broadcast Network 112 or the Local TV System 115 send TV programs and associated classification information, possibly with schedule information on request through a separate channel or automatically to the Set Top Box 124. The Set Top Box displays the information on the display 122 for the TV Set 120 and receives interactions 303 from the viewer viewing the TV. The viewer is watching a program. The program while it is being viewed may be stored on local storage 305, or it may simply be a TV Program Guide entry 306, in which case watching the program means viewing the Guide entry. Channels being broadcast to the Set Top Box have classification information stored in a Classification Table 307 in the Set Top Box. Classification information consists of categories of program content and, names of other specific related TV programs, all of which are referred to as categories. Programs stored locally for later viewing have their classification information stored in a Classification Table 308. Programs listed in the TV Program Guide have their classification information stored in a Classification Table 309. These tables may be separate as shown or may be combined with other tables or media. These tables may also be resident on the Local TV System and accessed through the Set Top Box or TV.

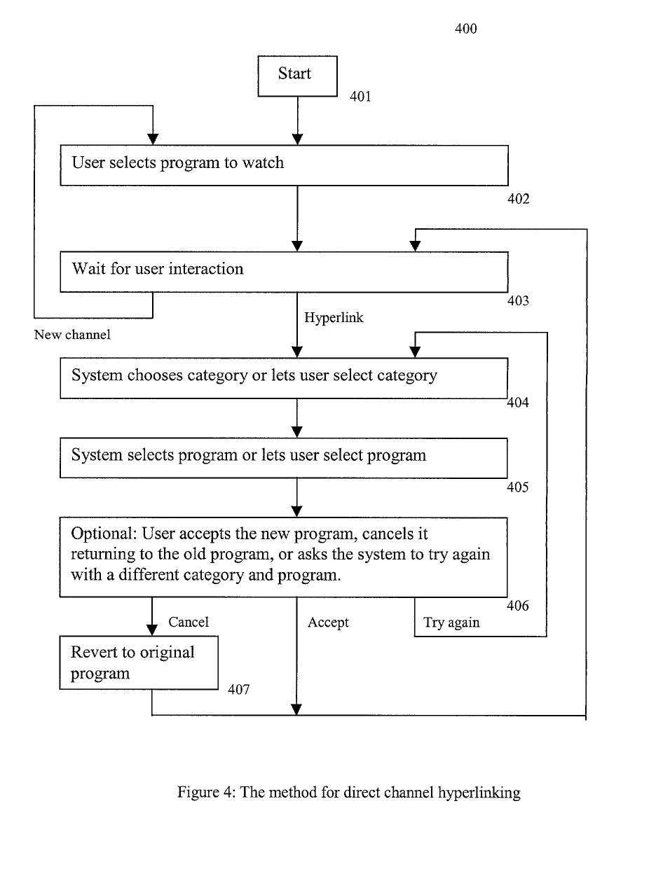

FIG. 4 in conjunction with FIGS. 1 and 3 shows a method 400 for direct channel hyperlinking using the data storage in FIG. 3 In step 401, the Set Top Box 124 is turned on and the viewer selects a program to watch in step 402. From time to time in step 403 the viewer may select a new program to watch or may ask to hyperlink to a new program related to the one being watched. In step 404 a hyperlink selection is activated by a viewer using the remote control 126 to “click on” on a hot spot in the image displayed on the TV screen 122. The system may choose or let the viewer choose among the various ways the program was classified, linking for example to another Sports program or another Football program or to another program that includes an actor in the previous program, provided that one or more programs are available, otherwise the offer to hyperlink is not sensitive to selection. Once the classification is chosen there will be at least one program to view. In step 405, if there are several programs to choose from, the system may select one or the viewer may be allowed to select one. In step 406, the viewer may then accept the program as chosen, which need involve no explicit viewer interaction. Alternatively, in step 407 the viewer may cancel the selected program and go back to the previous program that started the interaction, or the viewer may ask to try again selecting manually or letting the system select automatically a new category and program related to the previous program.

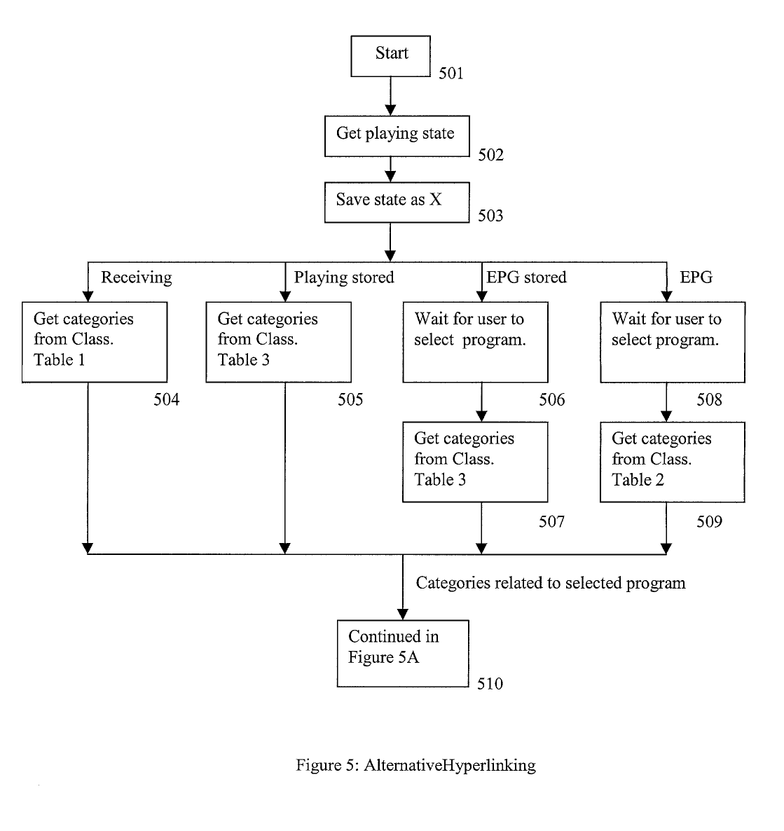

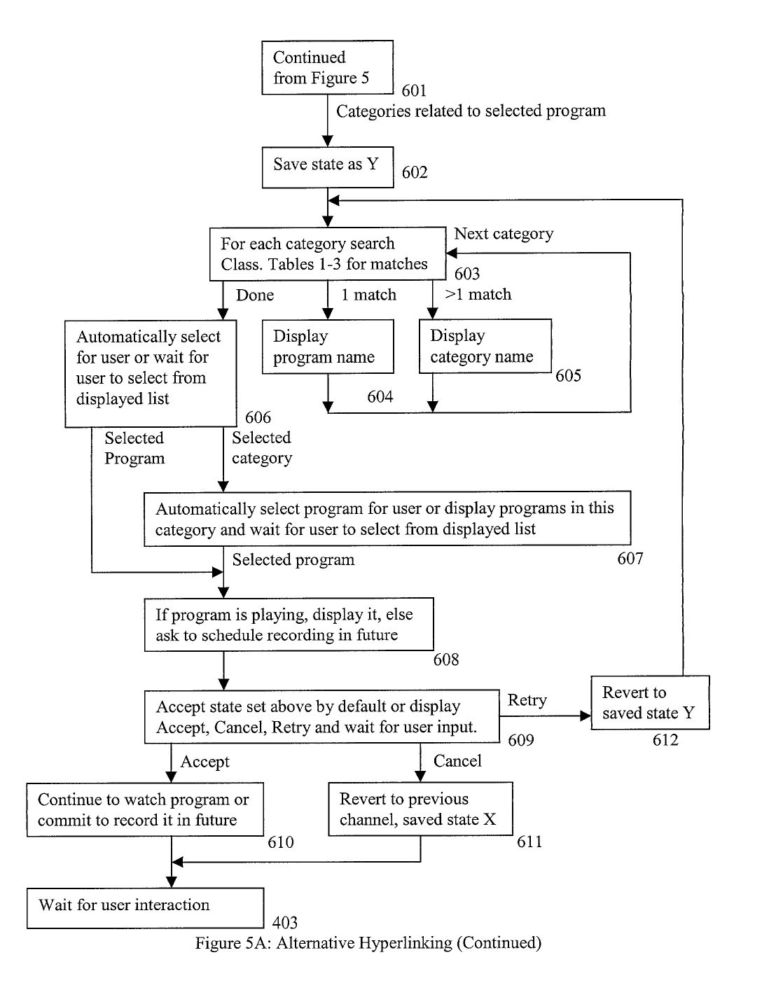

FIGS. 5 and 5A provide alternative embodiments of program hyper linking described in FIG. 4 at steps 403-407. FIG. 5 will be described in conjunction with FIG. 3 and 4. In describing FIGS. 5 and 5A, the term system is intended to mean programming stored at the TV broadcast station 104 and/or the local TV station 115 interacting with the set-top box 124 responsive to the remote control unit 122 (See FIG. 1) The system 100 first presents hyperlinks to new programs related to the one being watched in a process 500. In step 501 the process starts automatically or on request as previously described in FIG. 3. In step 502 the system queries the settop box hardware or software to determine which program is presently being viewed by the viewer. Step 503 stores the viewing state as state X, a state to which the viewer may choose to return to by canceling the coming interactions. Depending on the viewing state, one of four actions takes place. First, in step 504 the viewer is receiving and viewing a broadcast program. The channel number is obtained from the settop box, and the program entry for that channel in Classification Table 1 (307) is read to obtain the categories from Classification table 307 (See FIG. 3) in which that program is classified. The list of categories is stored in the system in step 510 for subsequent processing to be described in FIG. 5A. Second, in step 505 pre-recorded program played from onboard memory are being viewed by the viewer. The name of the viewed program is obtained from the settop box software that started the play and the entry for that program is read in Classification Table 3 (308) to obtain the categories in which that program is classified. The list of categories is stored in the system in step 510 for subsequent processing to be described in FIG. 5A. Third, in step 506 a list of programs stored locally (305), in effect a local electronic-program-guide (EPG) is being viewed except that the play time of any program is whenever the viewer wishes to play the program from local storage. The name of the program the viewer selects is obtained from the settop box software that stored the program in local storage, and the entry for that program in Classification Table 3 (308) is read in step 507 to obtain the categories in which that program is classified. The list of categories is stored in the system in step 510 for subsequent processing to be described in FIG. 5A. Fourth, in step 508 a list of programs in the local TV system's electronic-program-guide (EPG) is being viewed. The name of the program the viewer selects is obtained by interaction back to the local TV system or by local storage of these program names in the settop box, and the entry for that program is read in step 509 to obtain in Classification Table 2 (309) the categories in which that program is classified. The list of categories is stored in the system in step 510 for subsequent processing to be described in FIG. 5A.

Turning to FIG. 5A, processing of the list of categories of some viewer-selected program stored in step 510 is initiated in step 601. In step 602 the system state is saved as state Y to which the system will return if the user is unhappy with the hyperlink to a related program and wishes to try another related program. In step 603 each category in which the selected TV program is classified is processed. Recall that these “categories” can be both abstract types of programs or the names of specific related programs. In step 604 either the system finds the name of a specific program or the category of the selected program is compared to the categories of all programs in Classification Tables 1-3 and selects only one program that shares that category. The name of this program is displayed for the viewer to select and the process returns to step 603 to consider the next category of the specified program. In step 605 the system compares the category of the selected program to the categories of all programs in Classification Tables 1-3 and selects one more program that shares that category. The name of that category is displayed for the viewer to select. In step 606 the system either selects one of the above alternatives automatically, in which case the display of the selections may be omitted, or allows the user to select an alternative with the remote control. On the remote control occasion, the user selects a related program by a direct hyperlink in the program title and processing of the selection proceeds in step 608. If however in step 607 the viewer selects not a program but a displayed abstract category, then a final list of program names is obtained and the system then either automatically selects one or displays a list of program names for the user to select from. In step 608 the viewer has committed to leave the old selected program or EPG display and wishes to view the new selected program, the one the viewer wants to view next. Thus, in step 608 that new selected program starts to display, assuming it is being broadcast or that it is available in local stored memory, or else it a program to be broadcast in the future, in which case the system presents a standard dialog to ask the viewer if the selected program should be recorded at that time for later viewing or displayed immediately upon broadcast. In step 609 the viewer is optionally presented a dialog to approve the selection. The system may automatically accept the situation and continue to show the program or recording dialog (step 610), or the user may with the remote control select that option presented on the display screen. The system may present also the option to cancel the selection in which case in step 611 the system reverts to state X, saved in step 503 before the new program selection was done. In either case the system proceeds to step 403 (FIG. 4) to wait for the next viewer interaction. The system in step 609 may also present the option to retry finding a related program. If the user selects the option with the remote control 126 (FIG. 1), then in step 612 the system reverts to state Y saved in step 602, which is in preparation for selecting a new related program. Upon proceeding to step 603 a new program is selected automatically by the system or with the help of viewer selection of alternatives. The process 500 repeats as needed.

While the invention has been described in terms of a preferred embodiment, various changes can be made therein without departing from the spirit and scope of the invention as defined in the appended claims, in which:

We claim,

1. An interactive TV contextual content surfing system comprising:
a) creating apparatus, which creates program content for hyperlinking to other program content;
b) Broadcast apparatus which broadcast interactive TV program content with hyperlinks to other content;
c) receiver apparatus which receives and processes the interactive TV program content with hyperlinks for display to a viewer; and
d) enabling apparatus, which enables a viewer to hyperlink from a program being viewed to a related program.

2. The system of claim 1 further wherein the enabling apparatus enables the viewer to hyperlink from a scheduled or recorded program to a related program.

3. The system of claim 1 further wherein the enabling apparatus enables the viewer to hyperlink to a recording dialog when a related program may be in progress, previously recorded or scheduled or broadcast in the future.

4. The system of claim 1 further comprising:
g) broadcast apparatus which transmits audio/video program content and program classification, together or in separate channels to the receiver; and
h) control apparatus, which enables the viewer to interact with the program content and the program classification.

5. The system of claim 1 further comprising:
i) control apparatus at the receiver which groups program content by deduction based on viewer TV habits or information provided by the viewer.

6. The system of claim 1 further comprising:
J) receiver apparatus which provides alternative hyperlinking of program content.

7. An interactive TV contextual content surfing system using inter-channel hyperlinking, comprising:
(a) a content creation station generating and transmitting interactive program information and classification information in a data streaming format;
(b) a TV broadcast station for receiving the streaming data;
(c) a broadcast server for processing classification categories in the streaming data and hyperlinking program information in related categories;
(d) a network coupled to the TV broadcast station for transmitting in separate channels the TV program information and classification information to a local TV station for retransmission to TV devices equipped with set-top boxes or directly transmitting the program information directly to the set-top boxes; and
e) viewer means including an interface enabling a viewer to view a program in a category and using a hyperlink to switch to a new program related to the one being viewed.

8 The system of claim 7 further comprising:
(f) storing apparatus included in the broadcast server and stores a dynamic table of correspondence between TV program categories and TV channel numbers.

9. The system of claim 7 further comprising:
(g) server apparatus which creates a hyperlink list of channels that are broadcasting the same nature of programs by referencing the correspondence table.

10. The system of claim 7 further comprising:
(h) server apparatus which transmits the hyperlink information to the set-top box on a separate channel.

11. The system of claim 7 further comprising:
(i) set-top box apparatus which stores TV broadcasts by categories of programs in a first classification table.

12. The system of claim 7 further comprising:
(j) set-top box apparatus which stores categories of program in a TV program guide in a second classification table.

13. The system of claim 7 further comprising:
k) local storing apparatus in the set-top box which stores recorded programs and classifies categories of programs in a third classification table.

14. A method for interactive TV contextual content surfing using inter-channel hyperlink, comprising the steps of:
a) creating program content including a description of program type, producers, players, etc., for classification purposes;
b) transmitting the program content in a streaming data format to a broadcast station and a broadcast server;
c) generating a correspondence table between TV program categories and TV channel numbers in the broadcast server;
d) creating a hyperlink information of channels that are broadcasting the same nature of programs by referencing the correspondence table;
e) broadcasting the hyperlink information to the list of channels in the correspondence table;
f) transmitting the broadcast program information to a TV device including a set-top box via a first channel;
g) transmitting the hyperlinking information to the set-top box via a second channel; and
h) processing the broadcast hyperlinking information by the set-top box for display on a TV screen.

15. The method of claim 14 further comprising the step of
i) selecting a program to view in a category and hyperlinking to another program in the category.

16. The method of claim 14 further comprising the step of
j) creating a hyperlink list of channels that are broadcasting the same nature of programs by referencing the correspondence table.

17. The method of claim 14 further comprising the step of
k) storing a dynamic table of correspondence between TV program categories and TV channel numbers.

18. The method of claim 14 further comprising the step of:
l) storing recorded programs in a local storage and classifying categories of programs in local storage in a third classification table.

19. The method of claim 14 further comprising the step of:
m) storing TV broadcasts by categories of programs in a first classification table including a TV program guide in the set-top box.

20. The method of claim 14 further comprising the step of:
n) transmitting in separate channels the TV program information and classification information to a local TV station for retransmission to TV devices equipped with set-top boxes or directly transmitting the program information directly to the set-top boxes.

21. The method of claim 14 further comprising the step of:
o) generating and transmitting interactive program information and classification information in a data-streaming format.

22. A program medium, executable in a computer system for interactive TV contextual content surfing using inter-channel hyperlink, comprising:
a) program instructions in the medium which creates program content including a description of program type, producers, players, etc., for classification purposes;
b) program instructions in the medium which transmit the program content in a streaming data format to a broadcast station and a broadcast server;
c) program instructions in the medium which generates a correspondence table between TV program categories and TV channel numbers in the broadcast server;
d) program instructions in the medium, which creates a hyperlink information of channels that are broadcasting the same nature of programs by referencing the correspondence table;
e) program instructions in the medium, which broadcasts the hyperlink information to the list of channels in the correspondence table;
f) program instructions in the medium, which transmits the broadcast, program information to a TV device including a set-top box via a first channel;
g) program instructions in the medium which transmits the hyperlinking information to the set-top box via a second channel; and
h) program instructions in the medium which processes the broadcast hyperlinking information by the set-top box for display on a TV screen.

23. The program medium of claim 22 further comprising:
i) selecting a program to view in a category and hyperlinking to another program in the category.

24. The program medium of claim 22 further comprising:
j) creating a hyperlink list of channels that are broadcasting the same nature of programs by referencing the correspondence table.

25. The program medium of claim 22 further comprising:
k) storing a dynamic table of correspondence between TV program categories and TV channel numbers.

26. The program medium of claim 22 further comprising:
l) storing recorded programs in a local storage and classifying categories of programs in local storage in a third classification table.

27. A program medium, executable in an interactive TV computer system for contextual content surfing, comprising:
a) program instructions which create program content for hyperlinking to other program content;
b) program instructions which broadcast interactive TV program content with hyperlinks to other content;
c) program instructions which receives and processes the interactive TV program content with hyperlinks for display to a viewer; and
d) program instructions, which enables the viewer to hyperlink from a program being viewed to a related program.

28. The program medium of claim 27 further comprising:
e) program instructions, which enables a viewer to hyperlink from a scheduled or recorded program to a related program.

29. The program medium of claim 27 further comprising:
f) program instructions which enables a viewer to hyperlink to a recording dialog when a related program may be in progress, previously recorded or scheduled or broadcast in the future.

30. The program medium of claim 27 further comprising:
g) program instructions which broadcasts audio/video program content and program classification, together or in separate channels to the receiver; and
h) program instructions, which enables the viewer to interact with the program content and the program classification.

31. The program medium of claim 27 further comprising:
i) program instructions which groups program content at the receiver by deduction based on viewer TV habits or information provided by the viewer.

32. The program medium of claim 27 further comprising:
j) program instructions, which provides alternative hyperlinking of program content.

33. A method for contextual content surfing in an interactive TV computer system, comprising the steps of:
a) creating program content for hyperlinking to other program content;
b) broadcasting interactive TV program content with hyperlinks to other content;
c) receiving and processing the interactive TV program content with hyperlinks for display to a viewer; and
d) enabling the viewer to hyperlink from a program being viewed to a related program.

34. The method of claim 33 further comprising the step of:
e) enabling a viewer to hyperlink from a scheduled or recorded program to a related program.

35. The method of claim 33 further comprising the step of:
f) enabling a viewer to hyperlink to a recording dialog when a related program may be in progress, previously recorded or scheduled or broadcast in the future.

36. The method of claim 33 further comprising the step of:
g) broadcasting audio/video program content and program classification, together or in separate channels to the receiver; and
h) interacting with the program content and the program classification.

37. The method of claim 33 further comprising the step of:
i) grouping program content at the receiver by deduction based on viewer TV habits or information provided by the viewer.

38. The method of claim 33 further comprising the step of:
J) providing alternative hyperlinking of program content.

39. A broadcast server in a TV system, comprising:
a) a correspondence table storing means for a dynamic table of correspondence between TV program categories and TV channels number;
b) creation means for hyperlinking information which contains a list of channels broadcasting the same nature of program by referencing the correspondence table, and
c) transmitting means for the hyperlinking information to TV devices whereby upon successfully processing the broadcast hyperlinking information for display on a TV screen a viewer surfs among the channels specified in the hyperlinking information.

40. A method for surfing hyperlinked information in a TV system, comprising the steps of:
a) forming dynamic correspondence information of TV program categories and TV channels number;
b) creating hyperlinking information which contains a list of channels broadcasting the same nature of program by referencing the correspondence table, and
c) transmitting the hyperlinking information to TV devices whereby upon successfully processing the broadcast hyperlinking information for display on a TV screen a viewer surfs among the channels specified in the hyperlinking information.

41. A receiver for surfing hyperlinked information in a TV system, comprising:
a) storing apparatus, which receives program content including hyperlinks and related channels;
b) classification information in the storing apparatus which relates program content related to related channels; and
e) control apparatus, which enables a viewer to access the classification information and surf among related channels.

42. A method for surfing hyperlinked information in a TV receiver, comprising the steps of:
a) receiving program content including hyperlinks;
b) classifying received program content in tables according to the same content; and
e) enabling a viewer to access the tables and surf among the related content.

43. A broadcast server in a TV system, comprising:.
a) correspondence information between TV program categories and TV channels number;
b) creation apparatus which creates hyperlinking information of channels broadcasting the same nature of program categories by referencing the correspondence information, and
c) transmitting apparatus which transmits the hyperlinking information to TV devices whereby upon successfully processing the broadcast hyperlinking information for display on a TV screen, a viewer surfs among the channels specified in the hyperlinking information.

44. A receiver for surfing hyperlinked information in a TV system, comprising:
a) storing apparatus, which receives program content including hyperlinks and related channels;
b) classification information of program content related to the same channels; and
e) control apparatus, which enables a viewer to access the classification information and surf among related channels.
